(19) United States
(12) Patent Application Publication
(10) Pub. No.: US 2009/0077492 A1
(43) Pub. Date: Mar. 19, 2009

(54) ADDRESS LIST UPDATING APPARATUS AND METHOD FOR UPDATING ADDRESS LIST

(75) Inventor: Tomotaka Ida, Kumagaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/135,063

(22) Filed: Jun. 6, 2008

(30) Foreign Application Priority Data
Sep. 19, 2007 (JP) 2007242571

(51) Int. Cl. G06F 3/00; G06F 3/048

(52) U.S. Cl. 715/810; 710/4

(57) ABSTRACT

An address list updating apparatus includes: a memory that stores an address list that indicates correspondence between a physical address and a logical address of each of HDMI-CEC-compliant equipments; a reception unit that receives notification regarding the logical address and the physical address from each of the HDMI-CEC-compliant equipments; a transmission unit that, when the reception unit receives the notification containing a physical address that is registered in the address list, issues an inquiry to a target HDMI-CEC-compliant equipment having a logical address corresponding to the registered physical address; and an update unit that updates the address list by adding information included in the notification received from the target HDMI-CEC-compliant equipment when a response to the inquiry is received, and by deleting information regarding the target HDMI-CEC-compliant equipment when no response is received.

### CROSS-REFERENCE TO RELATED APPLICATIONS

This application is based upon and claims the benefit of priority from Japanese Patent Application No. 2007-242571, filed on Sep. 19, 2007, the entire content of which are incorporated herein by reference.

### BACKGROUND

1. Field

One embodiment of the present invention relates to an address list updating apparatus that is connected to a electronic apparatus having multiple functions through HDMI (High-Definition Multimedia Interface).

2. Description of the Related Art

Hitherto, a digital apparatus that is compliant with the HDMI standard has been known. An example of such apparatus is disclosed in JP-A-2007-158903.

In related art, an updating process for updating address list of an apparatus compliant with the HDMI standard is not designed to be capable of updating the address list for a HDMI-equipped apparatus that has a multiple functions when the apparatus is plugged out.

### SUMMARY

According to a first aspect of the present invention, there is provided an address list updating apparatus including: a memory that stores an address list that indicates correspondence between a physical address and a logical address of each of HDMI-CEC-compliant equipments for managing addresses of the HDMI-CEC-compliant equipments; a reception unit that receives notification regarding the logical address and the physical address from each of the HDMI-CEC-compliant equipments when the respective HDMI-CEC-compliant equipments are connected to the apparatus; a transmission unit that, when the reception unit receives the notification containing a physical address that is registered in the address list, issues an inquiry to a target HDMI-CEC-compliant equipment having a logical address corresponding to the registered physical address; and an update unit that updates the address list by adding information included in the notification received from the target HDMI-CEC-compliant equipment when a response to the inquiry is received from the target HDMI-CEC-compliant equipment, and by deleting information regarding the target HDMI-CEC-compliant equipment when no response to the inquiry is received from the target HDMI-CEC-compliant equipment.

According to a second aspect of the present invention, there is provided a method for updating an address list, the method including: storing an address list that indicates correspondence between a physical address and a logical address of each of HDMI-CEC-compliant equipments for managing addresses of the HDMI-CEC-compliant equipments; receiving notification regarding the logical address and the physical address from each of the HDMI-CEC-compliant equipments; issuing, when the reception unit receives the notification containing a physical address that is registered in the address list, an inquiry to a target HDMI-CEC-compliant equipment having a logical address corresponding to the registered physical address; and updating the address list by adding information included in the notification received from the target HDMI-CEC-compliant equipment when a response to the inquiry is received from the target HDMI-CEC-compliant equipment, and by deleting information regarding the target HDMI-CEC-compliant equipment when no response to the inquiry is received from the target HDMI-CEC-compliant equipment.

### BRIEF DESCRIPTION OF THE SEVERAL VIEWS OF THE DRAWINGS

A general configuration that implements the various feature of the invention will now be described with reference to the drawings. The drawings and the associated descriptions are provided to illustrate embodiments of the invention and not to limit the scope of the invention.

FIG. 1 is a block diagram to schematically show a system of a TV receiver installing an HDMI-CEC function according to a first embodiment of the present invention.

FIG. 2 is a drawing to show a connection example of connecting peripheral apparatuses to the system of the TV receiver using HDMI cables.

FIG. 3 is a flowchart to show a method of detecting an electronic apparatus.

FIG. 4 is a drawing to show logical addresses assigned to connected apparatuses.

FIG. 5 is a drawing to show information of peripheral apparatuses registered in an address list (management data table).

FIG. 6 is a drawing to show a connection example of connecting a multifunction HDD recorder to the TV receiver 100 in the connection example shown in FIG. 2.

FIG. 7 is a drawing to show an address list.

FIG. 8 is a drawing to show a connection example of connecting peripheral apparatuses to a system of a TV receiver using HDMI cables according to a second embodiment of the present invention.

FIG. 9 is a drawing to show a connection example of connecting a cable box in place of an HDD recorder connected to the TV receiver in the connection example shown in FIG. 8.

FIG. 10 is a drawing to show an address list (after the HDD recorder is removed).

FIG. 11 is a drawing to show the address list (after the cable box is connected).

FIG. 12 is a flowchart for displaying a function (HDMI input expansion switch) of displaying a list of device names already registered in an address list as a menu to perform input switch directly to a CEC apparatus with a TV receiver according to a third embodiment of the present invention after it is determined that a multifunction CEC apparatus of the first embodiment exists.

FIG. 13 is a drawing to show a screen example of HDMI input expansion switch.

FIG. 14 is a flowchart for displaying a function (channel banner display) for displaying input information output as video on a screen with a TV receiver according to a fourth embodiment of the present invention after it is determined that a multifunction CEC apparatus of the first embodiment exists.

FIG. 15 is a drawing to show a screen example of channel banner display.

FIG. 16 is a flowchart for executing a function (remote control pass-through function) of controlling as if the user pressed a remote control of a connected apparatus with a remote control of a TV receiver according to a fifth embodiment of the present invention after it is determined that a multifunction CEC apparatus of the first embodiment exists.

FIG. 17 is a drawing to show a screen example for executing the remote control pass-through function.

### DETAILED DESCRIPTION

Referring now to the accompanying drawings, there is shown an embodiment of the present invention.

### First Embodiment

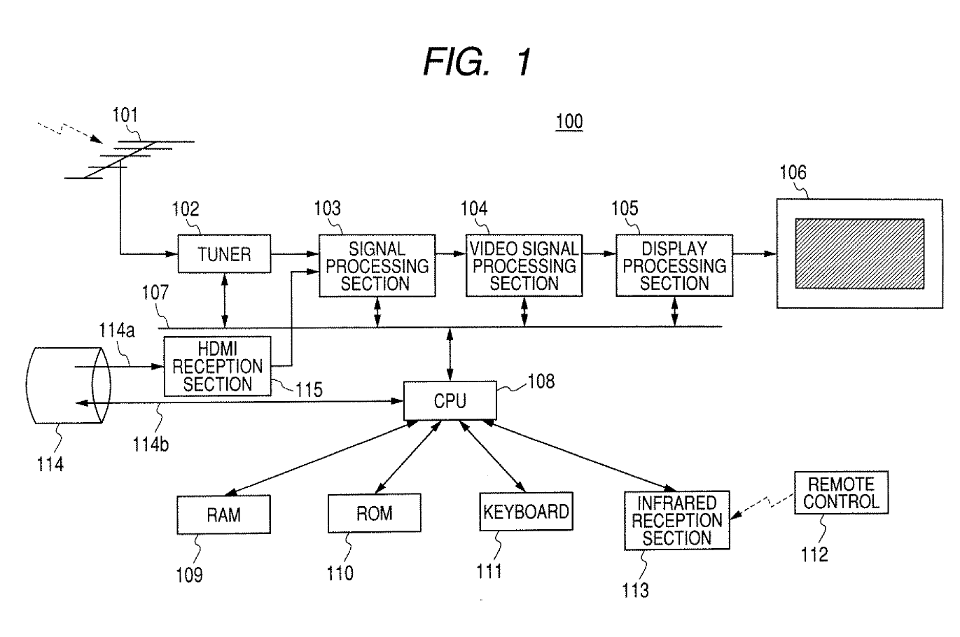

FIG. 1 is a block diagram to schematically show a system of a TV receiver 100 installing an HDMI-CEC function.

In FIG. 1, an antenna 101 receives a TV broadcast signal. A tuner 102 selects and demodulates any desired channel from the TV broadcast signals received at the antenna 101. A to signal processing section 103 demultiplexes the TV signal demodulated by the tuner 102 into a video signal, an audio signal, and other signals. If the broadcast is a digital broadcast, a plurality of programs are multiplexed in the demodulated transport stream (TS) and thus the signal processing section is 103 selects only the program desired by the user from among the programs.

A video processing section 104 adjusts the video signal input from the signal processing section 103 to an appropriate angle of view and appropriate color and outputs the 20 signal. A display processing section 105 converts the signal into a signal proper to a display section 106 and then outputs the signal to the display section 106. The display section 106 displays the video signal input from the display processing section 105 on a screen.

As the processing is thus performed, the desired program is displayed on the display section 106.

An image which is not a direct video input signal, such as a setting menu (graphical user interface (GUI)) is also created in the display processing section 105, etc., and is superposed on the video signal for display on the display section 106.

The blocks of the tuner 102, the signal processing section 103, the video processing section 104, and the display processing section 105 are connected to a CPU 108 via a communication line 107 and the CPU 108 controls the signal processing in the blocks described above.

The communication line 107 can be any of various connection modes of IIC-BUS (Inter-Integrated-Circuit bus), UART (Universal Asynchronous Receiver Transmitter) , etc., but the invention is not limited thereto.

The number of the CPUs 108 is not limited to one; two or more CPUs 108 may be used.

The CPU 108 is connected to RAM (random access memory) 109 for recording temporary data such as data for computation, RON (Read-Only Memory) 110 for recording data in a nonvolatile manner, a keyboard 111, an infrared reception section 113 for receiving an infrared signal from a remote control 112, and the like.

An HDMI cable 114 is made up of a signal and control line 114a and a CEC control line 114b.

A video signal, an audio signal, and a control signal are input to an HDMI reception section 115 through the signal and control line 114a input to the signal processing section 103.

The CEC control line 114b for communicating various pieces of information of HDMI apparatuses and communicating control instructions is connected to the CPU 108.

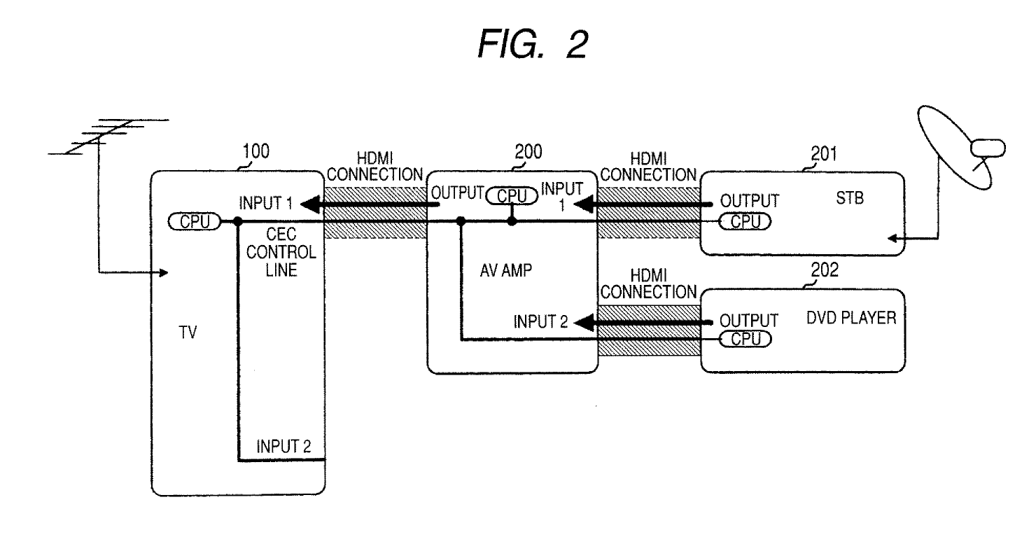

FIG. 2 is a drawing to schematically show a connection example of connecting peripheral apparatuses to the system of the TV receiver 100 previously described with reference to FIG. 1 using HDMI cables.

The TV receiver 100 is connected to an AV amplifier 200 of a peripheral apparatus using an HDMI cable. The AV amplifier 200 is connected to a set top box (STB) 201 and a DVD player 202 using HDMI cables.

The HDMI cable 114 contains the CEC control line 114b, which is connected to a CPU existing in each HDMI apparatus for control. The CEC control line 114b of the HDMI cable 114 is connected so that apparatus-to-apparatus communications can be conducted in all apparatuses.

The same or different types of antennas are connected to the TV receiver 100 and the STB 201. In the example shown in FIG. 2, a terrestrial antenna is connected to the TV receiver 100 and a satellite antenna is connected to the STB 201.

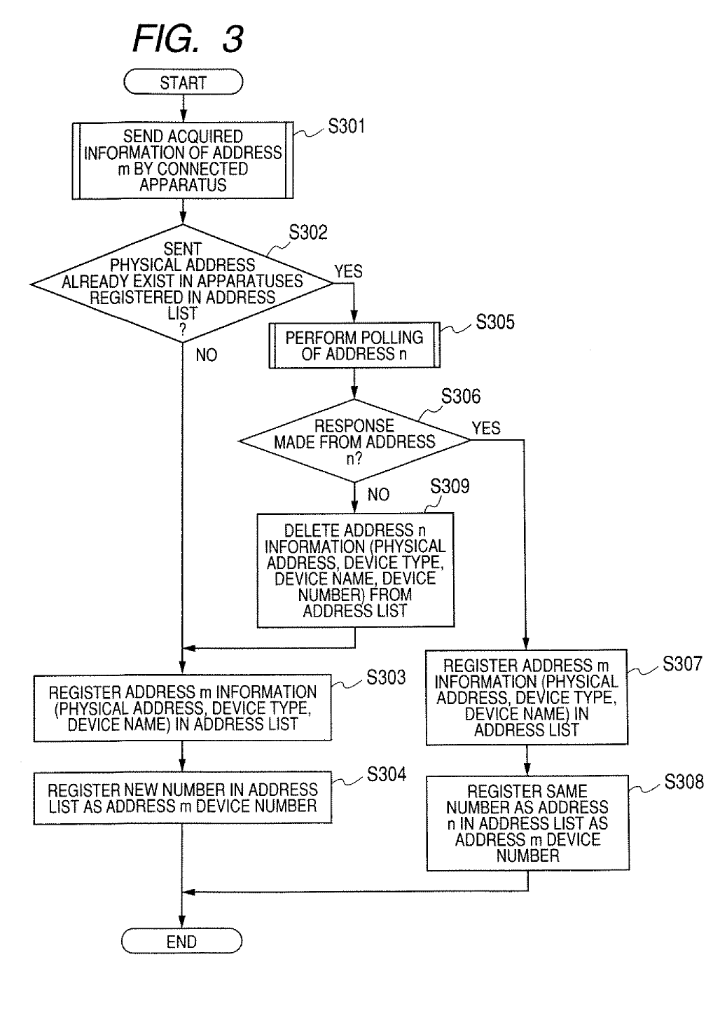

FIG. 3 is a flowchart to show a method of detecting a electronic apparatus in HDMI apparatuses each installing the HDMI-CEC function (which will be hereinafter referred to as CEC apparatuses) based on the system of the TV receiver 100 previously described with reference to FIG. 1 and the connection example of the system of the TV receiver 100 and the peripheral apparatuses previously described with reference to FIG. 2.

In the following description, it is assumed that power of the TV receiver 100 is turned on and is started and enters a state in which communications using the CEC control line can be conducted.

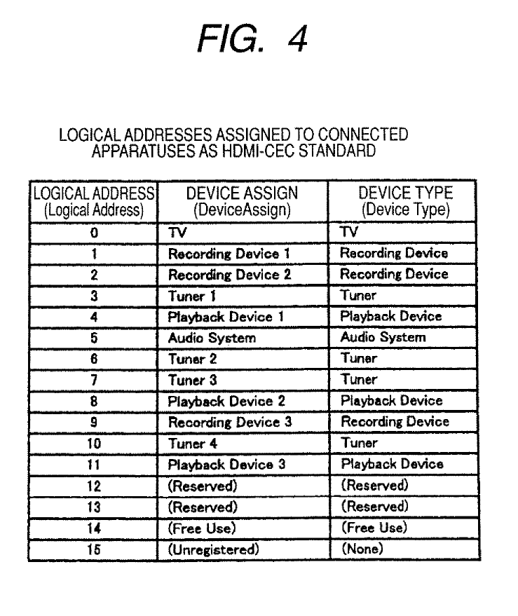

Further, as the HDMI-CEC standard, the connected apparatuses are assigned logical addresses shown in FIG. 4 and it is assumed that logical address 0 is already acquired as the TV receiver 100. Logical address 15 is the number of an indefinite number of apparatuses incapable of conducting active communications as CEC apparatuses.

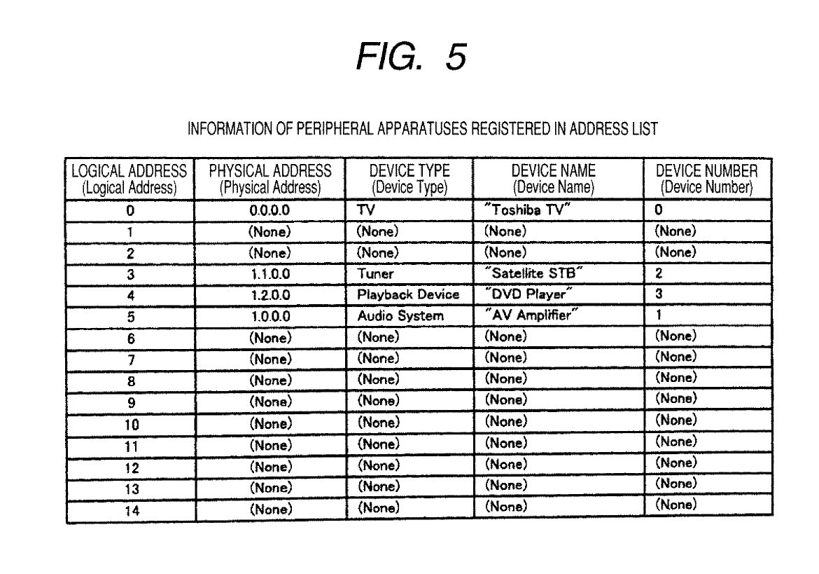

Further, in the connection example of the peripheral apparatuses in FIG. 2, a management data table indicating peripheral apparatus information shown in FIG. 5 is already registered in an address list in the RAM 109 or the ROM 110.

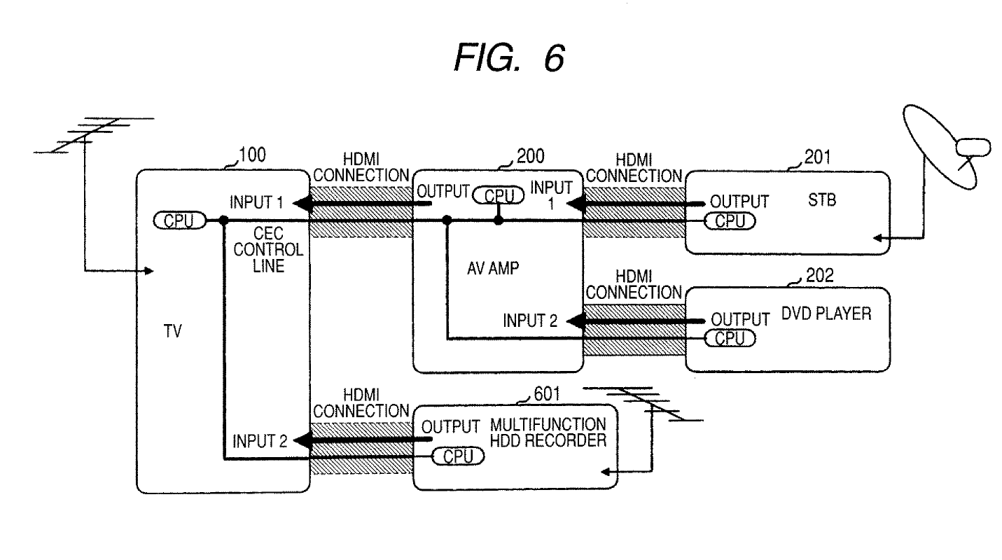

The operation in FIG. 3 will be discussed about an example of further connecting a multifunction HDD recorder 601 installing a large number of CEC functions to the TV receiver 100 as shown in FIG. 6 in the state. The multifunction HDD recorder 601 has three functions of (1) a recording apparatus function, (2) a tuner function, and (3) a playback apparatus.

When the multifunction HDD recorder 601 is connected as shown in FIG. 6 from the connection state shown in FIG. 2, the multifunction HDD recorder 601 acquires logical address 1 to install a recording apparatus function and uses a command of <Report Physical Address> defined in HDMI standard Ver. 1.2 to send physical address information to the TV receiver 100 (step S301).

Upon reception of the <Report Physical Address> command from the multifunction HDD recorder 601, the TV receiver 100 checks whether or not the sent physical address [2.0.0.0] already exists in the apparatuses registered in the address list (step S302).

When the physical address does not exist, new registration may be conducted and thus if the physical address sent from the multifunction HDD recorder 601 and the device type and further the device name can be acquired, the device name is registered as logical address 1 (step S303) and subsequently 4 not used as a new device number is registered as logical address 1 (step S304).

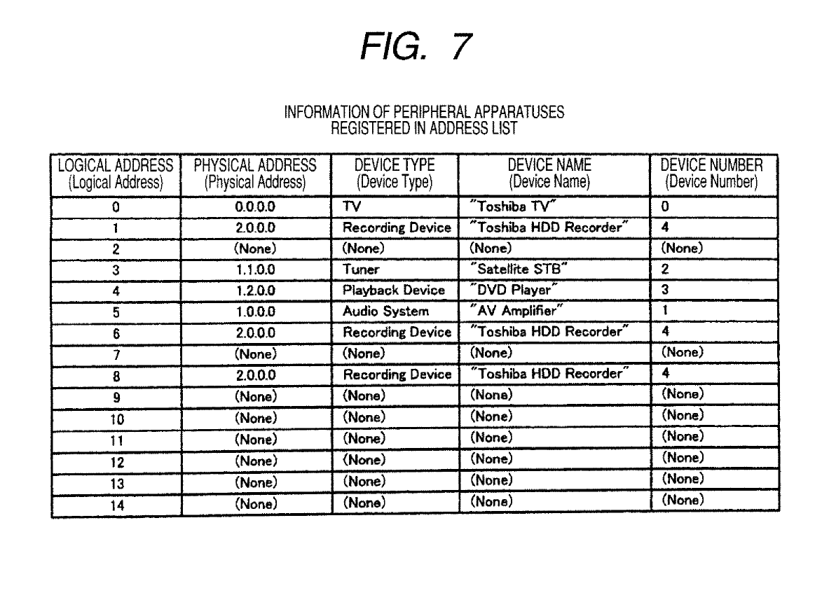

Here, it is assumed that the entries are registered as logical address 1 as shown in FIG. 7.

Next, the multifunction HDD recorder 601 acquires logical address 6 to install a tuner function and uses a command of <Report Physical Address> to send physical address information to the TV receiver 100 (step S301). Upon reception of the <Report Physical Address> command, the TV receiver 100 checks whether or not the sent physical address [2.0.0.0] already exists in the apparatuses registered in the address list (step S302).

Since physical address [2.0.0.0] is already registered in the address list as logical address 1, whether or not the logical address is still valid is inquired. To do this, a command of <Give Physical Address> or a command of <Polling> is used for polling (step S305). Whether or not a response to the polling is made is checked (step S306). To determine whether or not a response to the polling is made, polling at step S305 may be repeated five times, etc.

When a response to the polling is made, the logical address is still valid and thus the multifunction HDD recorder 601 is determined a multifunction CEC apparatus and if the physical address and the device type and further the device name can be acquired, the device name is registered as logical address 6 (step S307) and subsequently as the device number, the same 4 as in logical address 1 is registered as logical address 6 (step S308).

Here, it is assumed that the entries are registered as logical address 3 as shown in FIG. 7.

Next, likewise, the multifunction HDD recorder 601 acquires logical address 8 to install a playback apparatus function and uses a command of <Report Physical Address> to send physical address information to the TV receiver 100 (step S301). Upon reception of the <Report Physical Address> command, the TV receiver 100 checks whether or not the sent physical address [2.0.0.0] already exists in the apparatuses registered in the address list (step S302).

Since physical address [2.0.0.0] is already registered in the address list as logical addresses 1 and 6, whether or not the logical address is still valid is inquired. To do this, a command of <Give Physical Address> or a command of <Polling> is used for polling (step S305). Whether or not a response to the polling is made is checked (step S306) To determine whether or not a response to the polling is made, polling at step S305 may be repeated five times, etc.

When a response to the polling is made, the logical address is still valid and thus the multifunction HDD recorder 601 is determined a multifunction CEC apparatus and if the physical address and the device type and further the device name can be acquired, the device name is registered as logical address 8 (step S307) and subsequently as the device number, the same 4 as in logical address 1 is registered as logical address 8 (step S308).

Here, it is assumed that the entries are registered as logical address 8 as shown in FIG. 7.

On the HDMI-CEC standard, the same “Recording Type” may be used for the three functions of device type as described with FIG. 7 or “Recording Device,” “Tuner,” and “Playback Device” may be assigned to the three functions. In the description of the embodiment, the former is taken as an example.

Thus, the entries are registered in the address list as shown in FIG. 7, grouping is performed with the device number set to 4 according to the same physical address [2.0.0.0], and it is made possible to recognize a plurality of logical addresses (here, logical addresses 1, 3, and 8) as the same apparatus.

As described above, according to the invention, the address list can be updated considering a electronic apparatus as a plurality of functions are registered in one unit while a apparatus removed from HDMI connection is deleted from the address list.

In the embodiment, whether or not a response to the polling at step S305 is made is checked and a apparatus removed from HDMI connection is deleted from the address list, whereby the apparatus removed from HDMI connection can be quickly recognized and deleted.

### Second Embodiment

A system of a second embodiment of the present invention is similar to the system of the first embodiment previously described with reference to FIGS. 1 and 7 and therefore a redundant description will be omitted.

FIG. 3 with which the first embodiment has been described is a flowchart to show the method of detecting a electronic apparatus in CEC apparatuses and is also a flowchart to show the method of deleting the previous registration information if the apparatus is not a electronic apparatus.

The description made with reference to FIGS. 4 to 7 also applies to the second embodiment.

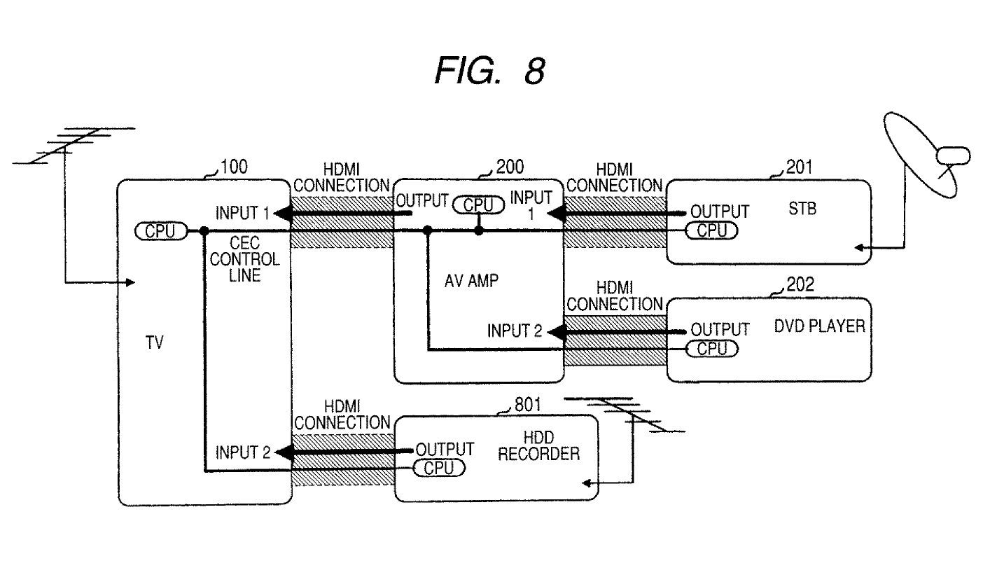

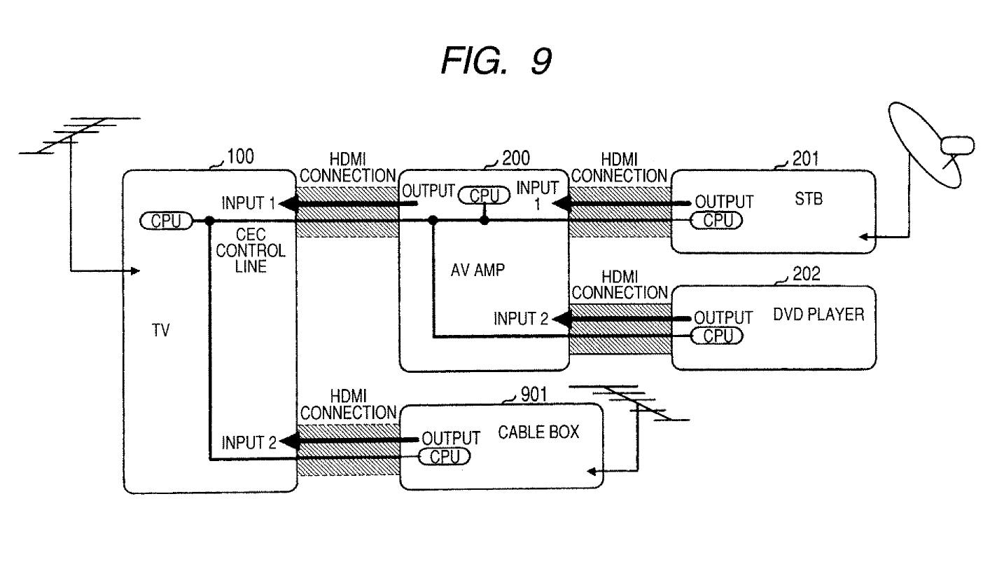

An example of further connecting a DVD recorder 801 having a recording function to a TV receiver 100 as shown in FIG. 8 in the state of the connection example of the peripheral apparatuses in FIG. 2 as in the first embodiment and then removing the DVD recorder 801 and connecting a cable box 901 having a tuner function as shown in FIG. 9 will be discussed.

When the DVD recorder 801 is connected to the TV receiver 100, the DVD recorder 801 acquires logical address 1 to install a recording apparatus function and uses a command of <Report Physical Address> defined in HDMI standard Ver. 1.2 to send physical address information to the TV receiver 100 (step S301). Upon reception of the <Report Physical Address> command, the TV receiver 100 checks whether or not the sent physical address [2.0.0.0] already exists in the apparatuses registered in an address list (step S302).

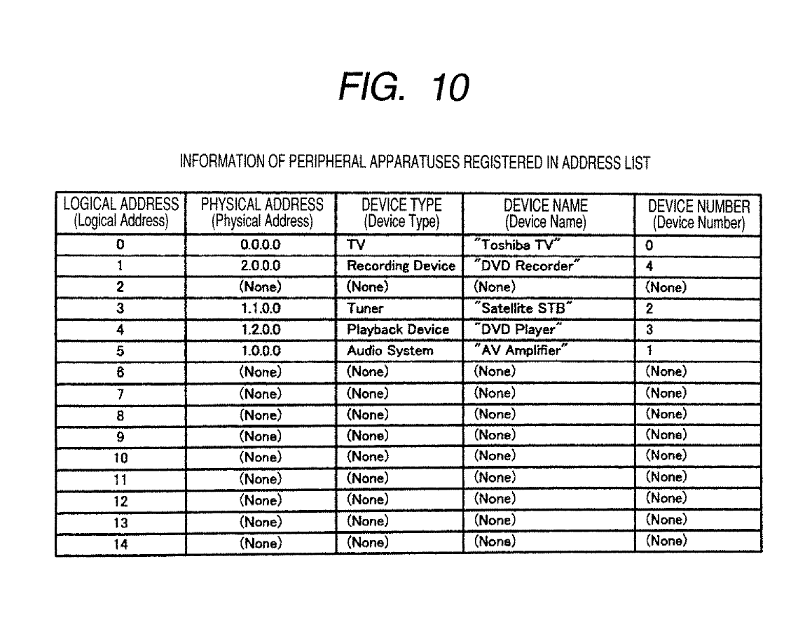

When the physical address does not exist, new registration may be conducted and thus if the physical address sent from the DVD recorder 801 and the device type and further the device name can be acquired, the device name is registered as logical address 1 (step S303) and subsequently 4 not used as a new device number is registered as logical address 1 (step S304). At this time, the entries are registered in the address list as shown in FIG. 10.

Next, the DVD recorder 801 is removed from the TV receiver 100 to set the connection configuration shown in FIG. 2. At this time, a command is not sent from the DVD recorder 801 and thus the TV receiver 100 holds the address list intact as shown in FIG. 10.

Next, when the cable box 901 is connected as shown in FIG. 9, the cable box 901 acquires logical address 6 to install a tuner function and uses a command of <Report Physical Address> to send physical address information to the TV receiver 100 (step S301). Upon reception of the <Report Physical Address> command, the TV receiver 100 checks whether or not the sent physical address [2.0.0.0] already exists in the apparatuses registered in the address list (step S302).

Since physical address [2.0.0.0] is already registered in the address list as logical address 1 as shown in FIG. 10, whether or not the logical address is still valid is inquired by polling (step S305). Whether or not a response to the polling is made is checked (step S306). To determine whether or not a response to the polling is made, polling at step S305 may be repeated five times, etc.

Here, the DVD recorder 801 is already removed and a response is not sent from the DVD recorder 801 and thus it is determined that logical address 1 is invalid and the DVD recorder 801 has been removed and information of logical address 1 is deleted (step S309).

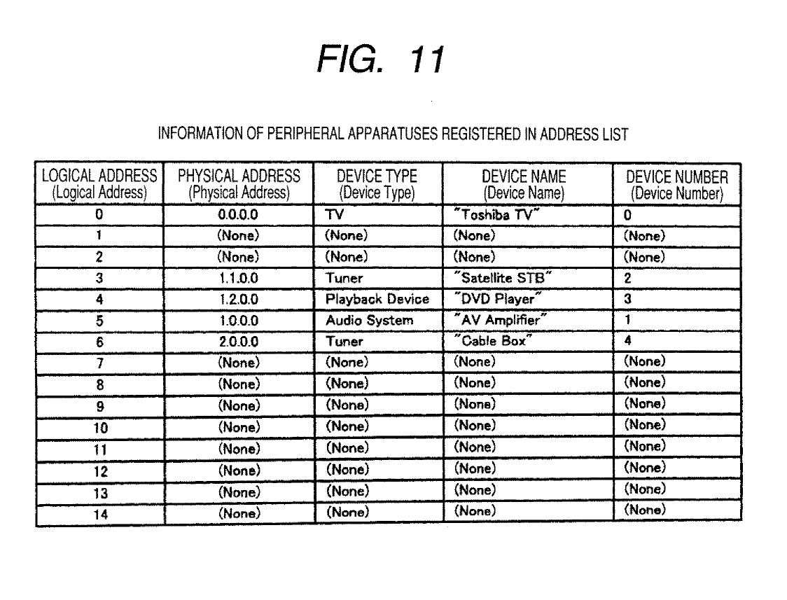

Subsequently, if the physical address sent from the cable box 901 and the device type and further the device name can be acquired, the device name is registered as logical address 6 (step S303) and subsequently as the device number, the same 4 as in logical address 1 is registered as logical address 6 (step S304). At this time, the entries are registered in the address list as shown in FIG. 11.

Thus, the information of the DVD recorder 801 can be immediately deleted, so that the user can recognize that the DVD recorder 801 is removed and does not exist in the system and further that the cable box 901 has been added.

As described above, according to the invention, the address list can be updated considering a electronic apparatus as a plurality of functions are registered in one unit while a apparatus removed from HDMI connection is deleted from the address list.

In the embodiment, whether or not a response to the polling at step S305 is made is checked and a apparatus removed from HDMI connection is deleted from the address list, whereby the apparatus removed from HDMI connection can be quickly recognized and deleted.

### Third Embodiment

A system of a third embodiment of the present invention is similar to the system of the first embodiment previously described with reference to FIGS. 1 and 7 and therefore redundant description will be omitted.

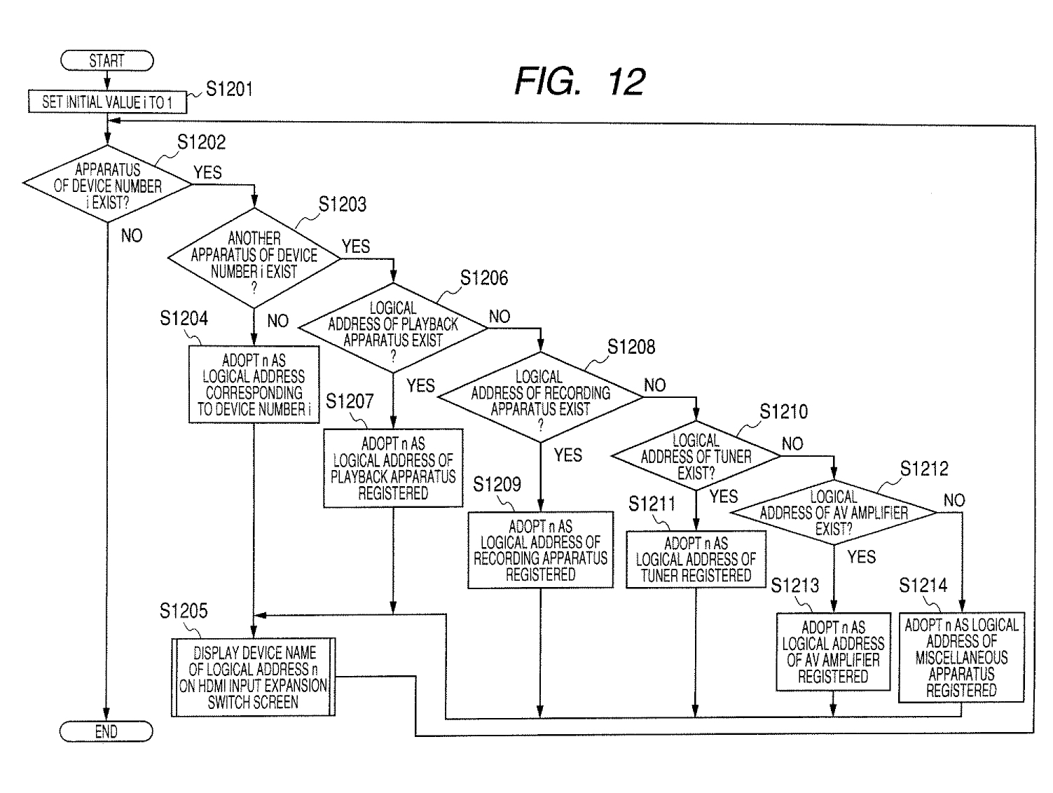

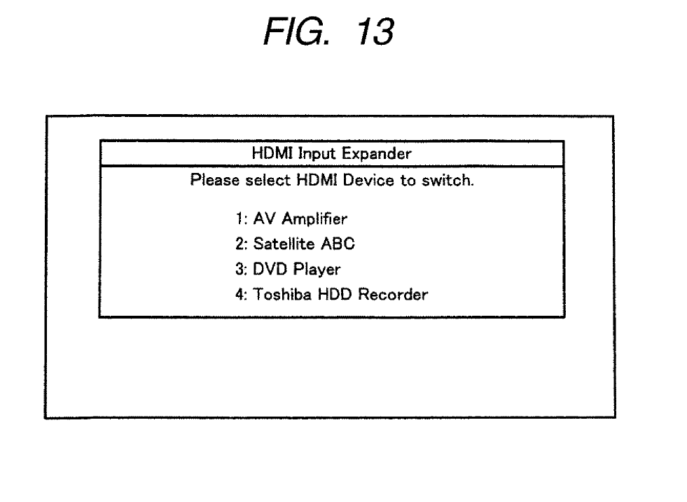

FIG. 12 is a flowchart for displaying a function of displaying a list of device names already registered in an address list as a menu to perform input switch directly to a CEC apparatus with a TV receiver 100 (hereinafter, the function will be referred to as HDMI input expansion switch) after it is determined that a multifunction CEC apparatus of the first embodiment exists. A screen as shown in FIG. 13 is possible as a screen example of HDMI input expansion switch. A method of displaying a screen as shown in FIG. 13 including the multifunction HDD recorder 601 of the first embodiment will be discussed about the flowchart.

It is assumed that the user presses a button for calling an HDMI input expansion switch menu with a remote control 112 of the TV receiver 100.

To display an HDMI input expansion switch menu, the device numbers in the address list (FIG. 7) stored in RAM 109 or ROM 110 are traced starting 1 (step S1201).

The address list is checked to see if a apparatus of device number 1 is registered (step S1202).

In the example, an AV amplifier of logical address 5 is applied and whether or not another logical address corresponding to the same device number exists is checked (step S1203).

In the example, only the AV amplifier of logical address 5 is applied and therefore (step S1204) device name “AV Amplifier” of logical address 5 is displayed in the HDMI input expansion switch (step S1205).

Subsequently, the address list is checked to see if a apparatus of device number 2 is registered (step S1202).

In the example, a tuner of logical address 3 is applied and whether or not another logical address corresponding to the same device number exists is checked (step S1203).

In the example, only the tuner of logical address 3 is applied and therefore (step S1204) device name “Satellite STB” of logical address 3 is displayed in the HDMI input expansion switch (step S1205) Subsequently, the address list is checked to see if a apparatus of device number 3 is registered (step S1202). In the example, a playback apparatus of logical address 4 is applied and whether or not another logical address corresponding to the same device number exists is checked (step S1203).

In the example, only the playback apparatus of logical address 4 is applied and therefore (step S1204) device name “DVD Player” of logical address 4 is displayed in the HDMI input expansion switch (step S1205).

Subsequently, the address list is checked to see if a apparatus of device number 4 is registered (step S1202).

In the example, a recording apparatus of logical address 1 is applied and whether or not another logical address corresponding to the same device number exists is checked (step S1203).

In the example, a tuner of logical address 6 and a playback apparatus of logical address 8 are applied in addition to the recording apparatus of logical address 1 and therefore the device number 4 indicates a electronic apparatus.

Next, whether or not the device number 4 involves a playback apparatus is checked (step S1206).

In the example, a playback apparatus of logical address 8 is applied and therefore (step S1207) device name “Toshiba HDD Recorder” of logical address 8 is displayed in the HDMI input expansion switch (step S1205).

When no playback apparatus exists, whether or not the device number 4 involves a recording apparatus is checked in a similar manner (step S1208). If a recording apparatus is involved, it is displayed (step S1209); if no recording apparatus is involved, whether or not the device number 4 involves a tuner is checked in a similar manner (step S1210). If a tuner is involved, it is displayed (step S1211); if no tuner is involved, whether or not the device number 4 involves an AV amplifier is checked in a similar manner (step S1212). If an AV amplifier is involved, it is displayed (step S1213); if no AV amplifier is involved, the apparatus is displayed as a miscellaneous apparatus (step S1214).

Subsequently, the address list is checked to see if a apparatus of device number 5 is registered (step S1202). In the example, a apparatus of device number 5 does not exist and therefore the display of the HDMI input expansion switch is completed.

Thus, as many apparatuses as the number of the device numbers are displayed without displaying as many apparatuses as the number of the registered logical addresses simply out of the address list, whereby it is made possible to avoid duplicate display and display as many apparatuses as the number of the actually connected apparatuses.

Further, redundant display and control is prevented, so that the system contributes to easiness of user's understanding, simplification of display, apparatus malfunction prevention, and lightening of communication load on the CEC control line.

### Fourth Embodiment

A system of a fourth embodiment of the present invention is similar to the system of the first embodiment previously described with reference to FIGS. 1 and 7 and therefore will not be discussed again in detail.

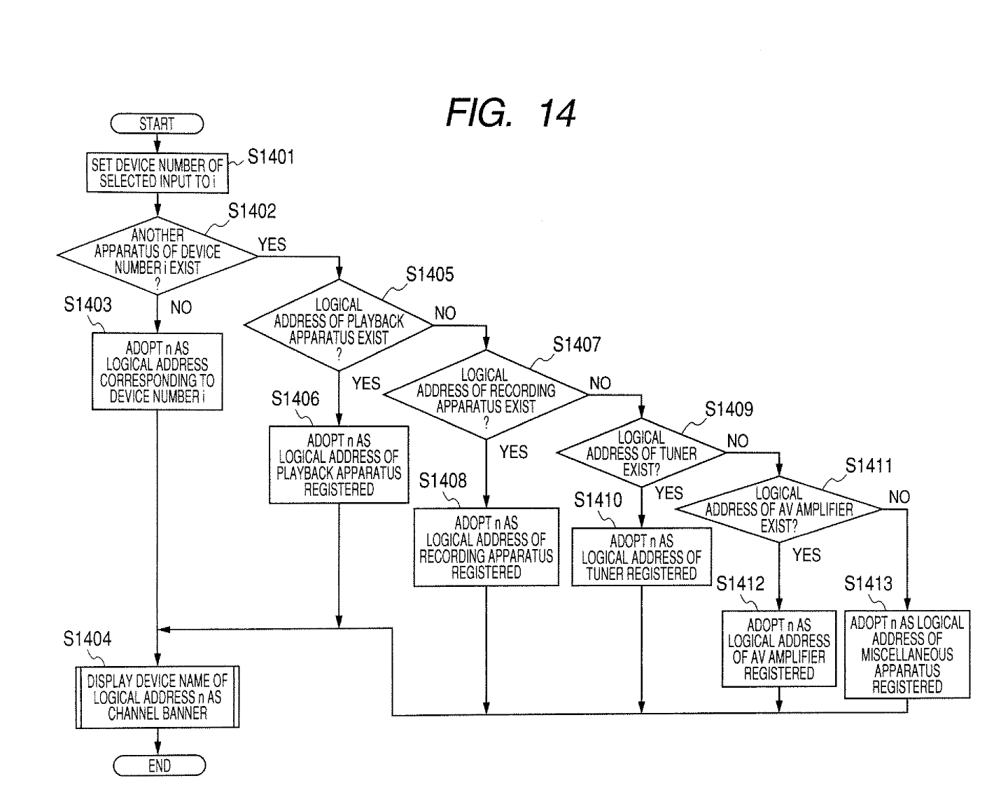

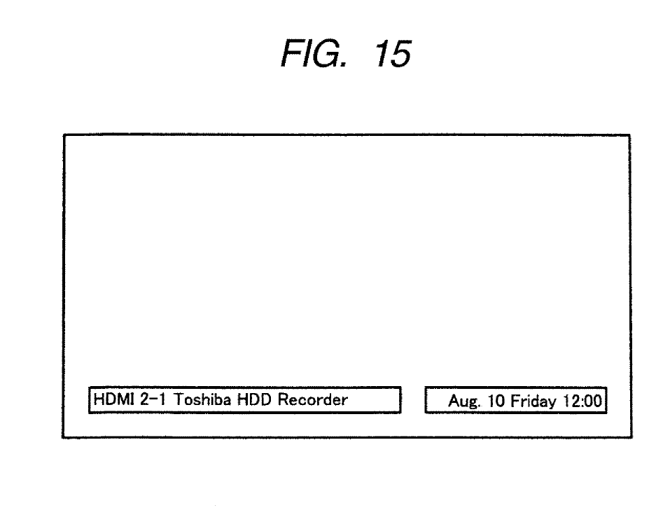

FIG. 14 is a flowchart for displaying a function of displaying input information output as video on a screen with a TV receiver 100 (hereinafter, the function will be referred to as channel banner display) after it is determined that a multifunction CEC apparatus of the first embodiment exists. A screen as shown in FIG. 15 is possible as a screen example of channel banner display. A method of displaying a screen as shown in FIG. 15 in a state in which the multifunction HDD recorder 601 of the first embodiment is selected as input will be discussed about the flowchart.

To begin with, the user presses a button for calling channel banner display with a remote control 112 of the TV receiver 100. For channel banner display, the device numbers in the address list (FIG. 7) stored in RAM 109 or ROM 110 are checked for device number 4 of the multifunction HDD recorder 601 (step S1401) to see if more than one logical address of the same device number exists (step S1402).

If only one logical address is applied, about the logical address, (step S1403) device name is displayed as a channel banner (step S1404).

In the example, a tuner of logical address 6 and a playback apparatus of logical address 8 are applied in addition to the recording apparatus of logical address 1 and therefore the device number 4 indicates a electronic apparatus.

Next, whether or not the device number 4 involves a playback apparatus is checked (step S1405).

In the example, a playback apparatus of logical address 8 is applied and therefore (step S1406) device name “Toshiba HDD Recorder” of logical address 8 is displayed as a channel banner (step S1404).

When no playback apparatus exists, whether or not the device number 4 involves a recording apparatus is checked in a similar manner (step S1407). If a recording apparatus is involved, it is displayed (step S1408); if no recording apparatus is involved, whether or not the device number 4 involves a tuner is checked in a similar manner (step S1409). If a tuner is involved, it is displayed (step S1410) ; if no tuner is involved, whether or not the device number 4 involves an AV amplifier is checked in a similar manner (step S1411). If an AV amplifier is involved, it is displayed (step S1412); if no AV amplifier is involved, the apparatus is displayed as a miscellaneous apparatus (step S1413).

Thus, if two or more device names are registered according to the same device number, it is made possible to select only one device name by making a selection according to the priority.

### Fifth Embodiment

A system of a fifth embodiment of the present invention is similar to the system of the first embodiment previously described with reference to FIGS. 1 and 7 and therefore will not be discussed again in detail.

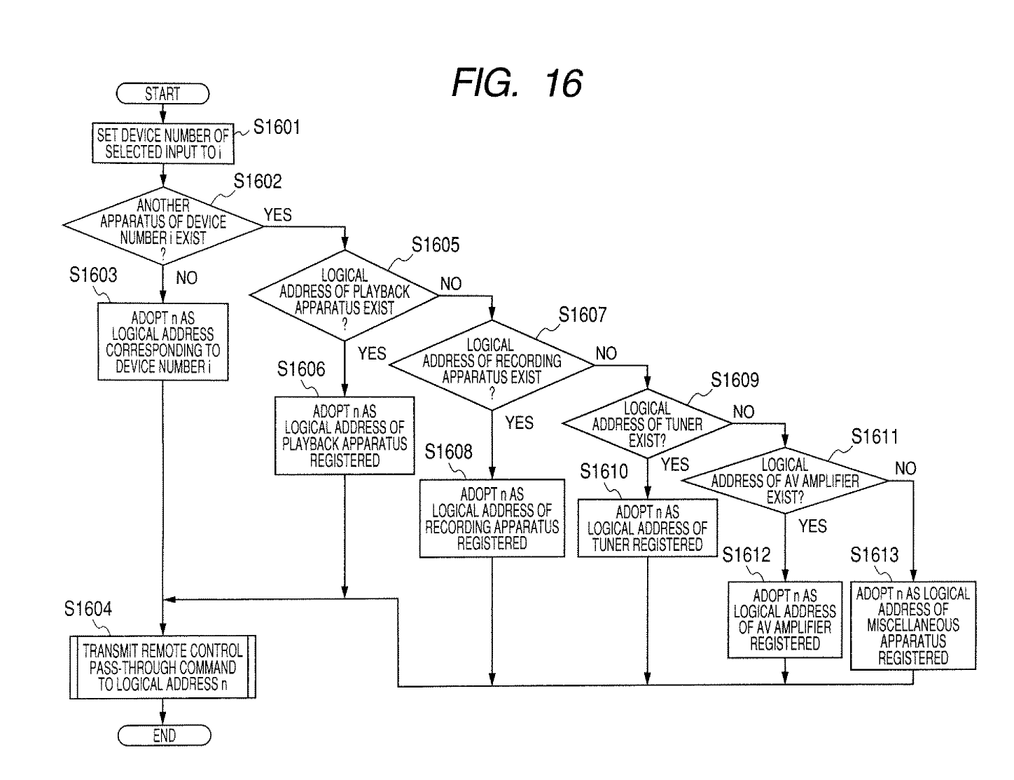

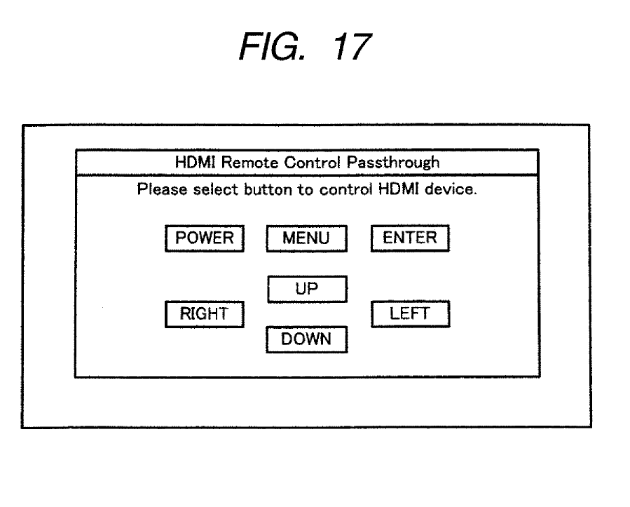

FIG. 16 is a flowchart for executing a function of controlling as if the user pressed a remote control of a connected apparatus with a remote control 112 of a TV receiver 100 (hereinafter, the function will be referred to as remote control pass-through function) after it is determined that a multifunction CEC apparatus of the first embodiment exists. A screen as shown in FIG. 17 is possible as a screen example to execute the remote control pass-through function. A method of executing the remote control pass-through function by button operation in FIG. 17 in a state in which the multifunction HDD recorder 601 of the first embodiment is selected as input will be discussed about the flowchart.

First, the user operates the remote control 112 of the TV receiver 100 to display an operation screen as in FIG. 17 and to activate the remote control pass-through function. To execute the remote control pass-through function, the device numbers in the address list (FIG. 7) stored in RAM 109 or ROM 110 are checked for device number 4 of the multifunction HDD recorder 601 (step S1601) to see if more than one logical address is of the same device number exists (step S1602).

When only one logical address is applied, to the logical address, (step S1603) remote control pass-through command is transmitted to a CEC control line 114b (step S1604).

Commands of <User Control Pressed> and <User Control Released> defined in HDMI standard Ver. 1.2 correspond to the remote control pass-through command. In the example, a tuner of logical address 6 and a playback apparatus of logical address 8 are applied in addition to the recording apparatus of logical address 1 and therefore the device number 4 indicates a electronic apparatus.

Next, whether or not the device number 4 involves a playback apparatus is checked (step S1605).

In the example, a playback apparatus of logical address 8 is applied and therefore (step S1606) remote control pass-through command is transmitted to the logical address 8 (step S1604).

When no playback apparatus exists, whether or not the device number 4 involves a recording apparatus is checked in a similar manner (step S1607). If a recording apparatus is involved, it is displayed (step S1608); if no recording apparatus is involved, whether or not the device number 4 involves a tuner is checked in a similar manner (step S1609). If a tuner is involved, remote control pass-through command is transmitted (step S1610); if no tuner is involved, whether or not the device number 4 involves an AV amplifier is checked in a similar manner (step S1611). If an AV amplifier is involved, remote control pass-through command is transmitted (step S1612); if no AV amplifier is involved, remote control pass-through command is transmitted to a miscellaneous apparatus (step S1613).

Thus, remote control pass-through command is transmitted to one logical address without transmitting remote control pass-through command to every logical address corresponding to the physical address selected as input from the address list, whereby it is made possible to lighten communications over the CEC control line in addition to preventing duplicate transmission and heavy control load on the apparatus.

It is to be understood that the present invention is not limited to the specific embodiment described above and that the present invention can be embodied with the components modified without departing from the spirit and scope of the claimed invention. The present invention may be embodied in various forms according to appropriate combinations of the components disclosed in the embodiment described above. For example, some components may be deleted from all components shown in the embodiment. Further, the components in different embodiments may be used appropriately in combination.

What is claimed is:

1. An address list updating apparatus comprising:
a memory that stores an address list that indicates correspondence between a physical address and a logical address of each of HDMI-CEC-compliant equipments for managing addresses of the HDMI-CEC-compliant equipments;
a reception unit that receives notification regarding the logical address and the physical address from each of the HDMI-CEC-compliant equipments when the respective HDMI-CEC-compliant equipments are connected to the apparatus;
a transmission unit that, when the reception unit receives the notification containing a physical address that is registered in the address list, issues an inquiry to a target HDMI-CEC-compliant equipment having a logical address corresponding to the registered physical address; and
an update unit that updates the address list by adding information included in the notification received from the target HDMI-CEC-compliant equipment when a response to the inquiry is received from the target HDMI-CEC-compliant equipment, and by deleting information regarding the target HDMI-CEC-compliant equipment when no response to the inquiry is received from the target HDMI-CEC-compliant equipment.

2. The apparatus according to claim 1 further comprising a display controller that controls a display device to display a selection screen for allowing a user to select one of the HDMI-CEC-compliant equipments based on the address list.

3. The apparatus according to claim 2, wherein the display controller controls the display device to display in the selection screen the HDMI-CEC-compliant equipments having the same physical addresses as a single equipment.

4. The apparatus according to claim 2, wherein the memory stores the address list indicating a device type and a device name of the respective HDMI-CEC-compliant equipments, and
wherein the display controller controls the display device to display in the selection screen the device name of one of the HDMI-CEC-compliant equipments having the same physical addresses, which has a predetermined device type.

5. The apparatus according to claim 1, wherein the memory stores the address list indicating a device type of the respective HDMI-CEC-compliant equipments, and
wherein the transmission unit that (1) searches an HDMI-CEC-compliant equipment having a predetermined device type from among the HDMI-CEC-compliant equipments having the same physical addresses and (2) transmits <User Control Pressed> command and <User Control Released> command once to the firstly found one of the HDMI-CEC-compliant equipments according to the search.

6. The apparatus according to claim 2 further comprising the display device that displays the selection screen.

7. A method for updating an address list, the method comprising:
storing an address list that indicates correspondence between a physical address and a logical address of each of HDMI-CEC-compliant equipments for managing addresses of the HDMI-CEC-compliant equipments;
receiving notification regarding the logical address and the physical address from each of the HDMI-CEC-compliant equipments;
issuing, when the reception unit receives the notification containing a physical address that is registered in the address list, an inquiry to a target HDMI-CEC-compliant equipment having a logical address corresponding to the registered physical address; and
updating the address list by adding information included in the notification received from the target HDMI-CEC-compliant equipment when a response to the inquiry is received from the target HDMI-CEC-compliant equipment, and by deleting information regarding the target HDMI-CEC-compliant equipment when no response to the inquiry is received from the target HDMI-CEC-compliant equipment.
